(19) United States
(12) Patent Application Publication
(10) Pub. No.: US 2011/0114362 A1
(43) Pub. Date: May 19, 2011

(54) DUAL FOAMED-SOLID WIRE INSULATION WITH MINIMAL SOLID

(75) Inventors: David M. FAUSZ, Fort Thomas, KY (US); Alexander P. YOUNG, Colerain Township, OH (US)

(73) Assignee: GENERAL CABLE TECHNOLOGIES CORPORATION, Highland Heights, KY (US)

(21) Appl. No.: 12/948,295

(22) Filed: Nov. 17, 2010

Related U.S. Application Data
(60) Provisional application No. 61/262,366, filed on Nov. 18, 2009.

(51) Int. Cl. H01B 11/02; B32B 27/00; B32B 3/26; B32B 3/00

(52) U.S. Cl. 174/113 R; 428/319.3; 428/304.4; 428/314.2

(57) ABSTRACT

The present invention provides insulation for a wire that comprises a main body configured to cover the wire where the main body has an inner surface that abuts the wire, an outer surface opposite the inner surface, and an insulation cross-sectional area defined between the inner and outer surfaces. A plurality of foamed sections are disposed in the insulation cross-sectional area of the main body. At least one solid section is disposed in the insulation cross-sectional area of the main body, wherein the plurality of foamed sections form at least 45% of the insulation cross-sectional area.

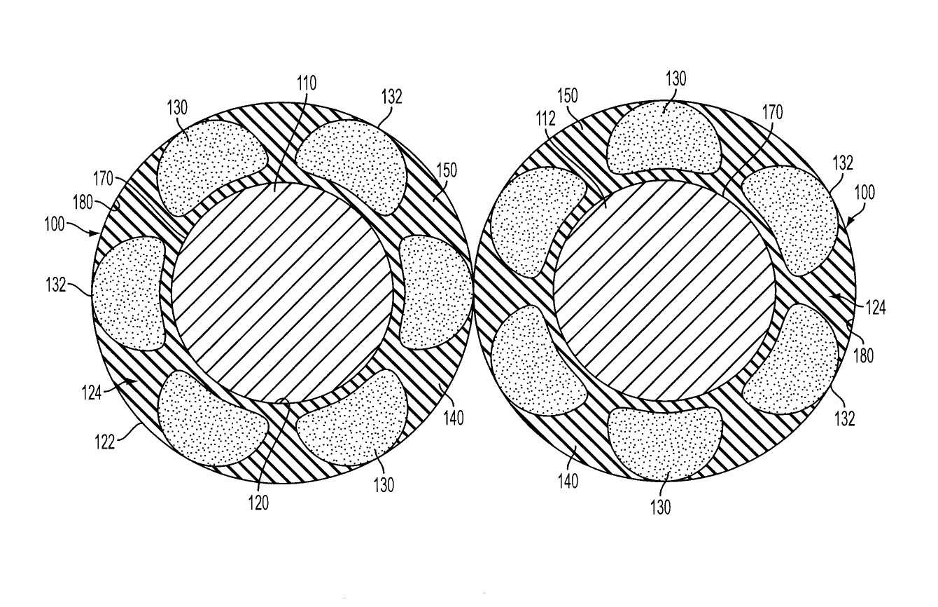

### RELATED APPLICATIONS

This application claims priority under 35 U.S.C. §119(e) to U.S. Provisional Application Ser. No. 61/262,366, filed Nov. 18, 2009.

### FIELD OF THE INVENTION

The present invention relates to insulation for wires, particularly wires in twisted pairs of data communication cabling. More specifically, the insulation may have both foamed and solid sections shaped and arranged such that a minimal amount of solid material is used while also providing insulation that resists crushing.

### BACKGROUND OF THE INVENTION

Data cables typically include a core of twisted wire pairs with each individual wire being insulated. When foam insulation is used, crushing of the insulation often occurs when the wire pairs are twinned or twisted together which can result in unwanted reduction in conductor-to-conductor spacing. That is because foam is physically weaker in tensile and compressive strength than solid insulation. Also, in current foaming methods, it is often difficult to control foam percentages within the extrusion operation due to a multitude of factors, such as back pressure, melt strength, and catalyst integration. In addition, during normal extrusion processes, such as pressure extrusion, it is not possible to create advantageous shapes on the insulated conductor. That is because pressure extrusion makes adding channels and shapes very difficult around wires. Solid insulation, however, is typically more expensive and often fails flame testing because it generates much more smoke than foamed materials.

Therefore, a need exists for a wire insulation that is less expensive, passes flame twisting, and also avoids crushing.

### SUMMARY OF THE INVENTION

Accordingly, the present invention provides insulation for a wire that comprises a main body configured to cover the wire where the main body has an inner surface that abuts the wire, an outer surface opposite the inner surface, and an insulation cross-sectional area defined between the inner and outer surfaces. A plurality of foamed sections are disposed in the insulation cross-sectional area of the main body. At least one solid section is disposed in the insulation cross-sectional area of the main body, wherein the plurality of foamed sections form at least 45% of the insulation cross-sectional area.

The present invention also provides insulation for a wire that comprises a main body configured to cover the wire where the main body has an inner surface that abuts the wire, an outer surface opposite the inner surface, and an insulation cross-sectional area defined between the inner and outer surfaces. A plurality of foamed sections are disposed in the insulation cross-sectional area of the main body. At least one solid section is disposed in the insulation cross-sectional area of the main body, wherein the at least one solid section is a center material that substantially covers the circumference of the wire.

The present invention further provides insulation for a wire that comprises a main body configured to cover the wire where the main body has an inner surface that abuts the wire, an outer surface opposite the inner surface, and an insulation cross-sectional area defined between the inner and outer surfaces. A plurality of foamed sections are disposed in the insulation cross-sectional area of the main body. At least one solid section is disposed in the insulation cross-sectional area of the main body, wherein the at least one solid section is a peripheral material that encompasses substantially the entire insulation cross-sectional area at the outer surface of the main body.

The present invention also provides a twisted pair of first and second wires that comprises a first insulation that covers the first wire. The first insulation has a main body configured to cover the first wire, the main body has an inner surface that abuts the first wire, and an outer surface is opposite the inner surface. An insulation cross-sectional area is defined between the inner and outer surfaces. A second insulation covers the second wire. The second insulation has a main body configured to cover the second wire, the main body has an inner surface that abuts the second wire, and an outer surface is opposite the inner surface. An insulation cross-sectional area is defined between the inner and outer surfaces. A plurality of foamed sections are disposed in each of the insulation cross-sectional areas of the first and second insulations. At least one solid section is disposed in each of the insulation cross-sectional areas of the first and second insulation. The plurality of foamed sections form at least 45% of the insulation cross-sectional areas of the first and second insulations, respectively.

Other objects, advantages and salient features of the invention will become apparent from the following detailed description, which, taken in conjunction with the annexed drawing, discloses a preferred embodiment of the present invention.

### BRIEF DESCRIPTION OF THE DRAWING

A more complete appreciation of the invention and many of the attendant advantages thereof will be readily obtained as the same becomes better understood by reference to the following detailed description when considered in connection with the accompanying drawing FIGURE, which is a cross-sectional view of insulation covering two wires of a wire pair.

### DETAILED DESCRIPTION OF THE INVENTION

The insulation in accordance with the present invention mitigates the problems of foam wire insulation and solid wire insulation by leveraging the stronger solid materials in key areas within the insulation. The insulation of the present invention minimizes crushing while also maintaining the highest degree of foaming, thereby reducing costs and improving performance of the data cable for cost, performance, etc.

Referring to the FIGURE, insulation 100 in accordance with an exemplary embodiment of the present invention covers wires 110 and 112, respectively. The wires 110 and 112 are preferably twinned to form a twisted wire pair, as is well known in the art of data cabling. The insulation 100 includes a main body with an inner surface 120 that covers the individual wire 110 or 112 and an opposite outer surface 122. Defined between the inner and outer surfaces 120 and 122 is an insulation cross-sectional area 124. The cross-sectional area 124 may be about 18.4 mils wide, for example. The insulation 100 preferably has both foamed and unfoamed or solid sections 130 and 140 in the insulation cross-sectional area 124 that run longitudinally with respect to the wires 110 and 112. For example, the insulation 100 may include a plurality of foamed sections 130 circumferentially arranged around the wire. The foamed sections 130 may be uniformly spaced around the wire with solid sections therebetween. Each foamed section 130 is nearly surrounded by or embedded in the solid section 140. The dispersed arrangement of the foamed sections 130 defines solid beams 150 consisting of more rigid material running between each of the foamed sections 130 all the way from the inner surface 120 to the outer surface 122 of the insulation 100. The foamed sections 130 may have a generally triangular cross-sectional shape; however the foamed sections 130 may have any cross-sectional shape including circular. For example, the foamed sections 130 may be about 7.5 mils long and 9 mils wide, for example. The beams 150 act as support structures helping to minimize the crushing of the foamed sections 130 and thus crushing of the insulation.

In a preferred embodiment, a center material 170 of the insulation 100 is adjacent the inner surface 120 and extends around the circumference of the wire between the inner surface 120 and the foamed sections. The center material 170 is preferably nearly solid or 100% solid, as seen in the FIGURE. The center material 170 may have a width that is about 1 mil in cross-section, for example. That helps eliminate some of the issues that arise from having foam against the wire (irregular bubbles, air pockets, etc) that harm the electrical properties of the data cable. The center material 170 may be thin compared to other solid sections 140 to create a thin solid skin around the wire 110 or 112 as that is all that is needed to protect the electrical properties of the wire, thereby minimizing the use of solid material. Another desired effect of having the material 170 against the wire being all or generally solid is that adhesion to the wire is better compared to that of having only foam against the conductor.

A peripheral material 180 of the insulation 100 near or closest to the outer surface 122 of the insulation 100 may also be nearly solid or 100% solid. Because the solid material is harder than the foamed material, the peripheral material 180 of the insulation thus has far better compression resistance. By maintaining a mostly solid surface at the peripheral material 180 of the insulation (for example, an area >75% of the insulation's cross-section), the compression of the foam is greatly reduced as the harder material absorbs the compressive forces on the surface layer 122 of the insulation. Such compressive resistance helps prevent the crushing that happens during the twinning process, especially for foamed materials. Some foamed material 130, however, may be exposed at portions 132 of the surface layer 122, as seen in the FIGURE. The portions 132 may be about 1.5 mils wide, for example. That allows for easier tooling and extrusion than if the foamed sections were completely enclosed in the insulation.

Although the center material 170 and the peripheral material 180 of the insulation are preferably solid, the design of the insulation 100 is such that the foam content is maximized and solid content is minimized while electrical properties are preserved and crushing is reduced. To achieve that, it is preferable that the cross-sectional surface area of the insulation 100 should consist of a minimum 45% foamed sections 130, for example. With at least 45% foamed sections 130, the electrical properties of the wire pair are maintained as is the desired crush resistance. Also, ease of manufacture is taken into consideration by having foamed material exposed on the surface.

Adhesion along the boundaries of the foamed and solid sections 130 and 140 can be maximized in accordance with the present invention to provide better physical strength and tensile properties for the insulation 100. As shown in the FIGURE, to achieve the surface area requirements as to the percentage of foam, the foamed sections 130 may have a tapered profile. That increases the length or overall size of the boundaries between the foamed and solid sections 130 and 140. That also helps to increase the adhesion between the sections 130 and 140 as contact between the two is maximized, providing for a physically stronger insulation.

In accordance with an exemplary embodiment of the present invention, the foamed sections 130 make up 49.5% of the insulation's cross-sectional area. That percentage could be increased by expanding the width of the foamed sections 130. The foamed sections 130 may also be expanded at the portions 132 of the surface layer 122 of the insulation 100 while still keeping the surface area over 80% solid. Thus, the design of insulation 100 leverages higher compressive solid material in key areas to protect against crushing and reduced electrical properties.

Because the insulation 100 contains a high percentage of foam, the fuel load is reduced, thus improving flame and smoke characteristics by creating air pockets where compound once existed. In addition, certain electrical characteristics like dissipation factor, attenuation, and capacitance can be improved by use of a reduced crushed foam insulation and/or a solid insulation. Also, by minimizing the use of solid materials, materials costs are significantly reduced.

The materials used to make the foamed and solid sections 130 and 140 of the insulation 100 may be the same or different. For example, the foamed and solid sections 130 and 140 may be formed of FEP, HDPE, perfluoromethylvinylether (MFA), Halar, PVC, and other fluropolymers, or resins, such as Polystyrene (PS) or Ethylene Vinyl Acetate (EVA). Moreover, the foamed sections 130 may be foamed either before or after twinning the wires 110 and 112 into a twisted wire pair.

While a particular embodiment has been chosen to illustrate the invention, it will be understood by those skilled in the art that various changes and modifications can be made therein without departing from the scope of the invention as defined in the appended claims. For example, although the design of the insulation 100 is preferably the same for both individual wires 110 and 112, as seen in the FIGURE, the insulation for each wire may be different. That is, the shapes of the foamed and solid sections 130 and 140 for the insulation of the wire 110 may be different than the shapes of the foamed and solid sections 130 and 140 for the insulation of the wire 112. Also, the percentage of foam and solid material may be different.

What is claimed is:

1. Insulation for a wire, comprising:
a main body configured to cover the wire, said main body having an inner surface that abuts the wire, an outer surface opposite said inner surface, and an insulation cross-sectional area defined between said inner and outer surfaces;
a plurality of foamed sections disposed in said insulation cross-sectional area of said main body; and
at least one solid section disposed in said insulation cross-sectional area of said main body,
wherein said plurality of foamed sections form at least 45% of said insulation cross-sectional area.

2. Insulation according to claim 1, wherein
said at least one solid section substantially surrounds said plurality of foamed sections.

3. Insulation according to claim 1, wherein
said plurality of foamed sections are spaced from the wire.

4. Insulation according to claim 1, wherein
at least a portion of each of said plurality of foamed sections is exposed at said outer surface of said main body.

5. Insulation according to claim 1, wherein
said main body is formed of one of FEP, HDPE, MFA, Halar, PVC, fluropolymer, PS, and EVA.

6. Insulation according to claim 1, wherein
said foamed sections have a substantially triangular cross-sectional shape.

7. Insulation according to claim 1, wherein
said at least one solid section is a center material surrounding said wire.

8. Insulation according to claim 1, wherein
said at least one solid section is a peripheral material adjacent said outer surface of said main body and surrounding said foamed sections.

9. Insulation for a wire, comprising:
a main body configured to cover the wire, said main body having an inner surface that abuts the wire, an outer surface opposite said inner surface, and an insulation cross-sectional area defined between said inner and outer surfaces;
a plurality of foamed sections disposed in said insulation cross-sectional area of said main body; and
at least one solid section disposed in said insulation cross-sectional area of said main body,
wherein said at least one solid section is a center material that substantially covers the circumference of the wire.

10. Insulation according to claim 9, further comprising
a second solid section that is a peripheral material that substantially surrounds said plurality of foamed sections.

11. Insulation according to claim 9, wherein
said main body is formed of one of FEP, HDPE, MFA, Halar, PVC, fluropolymer, PS, and EVA.

12. Insulation according to claim 9, wherein
at least a portion of each of said plurality of foamed sections is exposed at said outer surface of said main body.

13. Insulation according to claim 9, wherein
said plurality of foamed sections form at least 45% of said insulation cross-sectional area.

14. Insulation for a wire, comprising:
a main body configured to cover the wire, said main body having an inner surface that abuts the wire, an outer surface opposite said inner surface, and an insulation cross-sectional area defined between said inner and outer surfaces;
a plurality of foamed sections disposed in said insulation cross-sectional area of said main body; and
at least one solid section disposed in said insulation cross-sectional area of said main body,
wherein said at least one solid section is a peripheral material that encompasses substantially the entire said insulation cross-sectional area at said outer surface of said main body.

15. Insulation according to claim 14, wherein
said at least one solid section substantially surrounds said plurality of foamed sections.

16. Insulation according to claim 14, wherein
said at least one solid section forms at least 75% of said outer surface of said main body.

17. Insulation according to claim 14, wherein
at least a portion of each of said plurality of foamed sections is exposed at said outer surface of said main body.

18. Insulation according to claim 14, wherein
said plurality of foamed sections form at least 45% of said insulation cross-sectional area.

19. Insulation according to claim 14, wherein
said main body is formed of one of FEP, HDPE, MFA, Halar, PVC, fluropolymer, PS and EVA.

20. Insulation according to claim 14, wherein
said foamed sections have a substantially triangular cross-sectional shape.

21. A twisted pair of first and second wires, comprising:
a first insulation covering the first wire, said first insulation having a main body configured to cover the first wire, said main body having an inner surface that abuts the first wire, an outer surface opposite said inner surface, and an insulation cross-sectional area defined between said inner and outer surfaces;
a second insulation covering the second wire, said second insulation having a main body configured to cover the second wire, said main body having an inner surface that abuts the second wire, an outer surface opposite said inner surface, and an insulation cross-sectional area defined between said inner and outer surfaces;
a plurality of foamed sections disposed in each of said insulation cross-sectional areas of said first and second insulations; and
at least one solid section disposed in each of said insulation cross-sectional areas of said first and second insulation,
whereby said plurality of foamed sections form at least 45% of said insulation cross-sectional areas of said first and second insulations, respectively.
